(19) United States
(12) Patent Application Publication
(10) Pub. No.: US 2006/0284476 A1
(43) Pub. Date: Dec. 21, 2006

(54) System and method for authorizing a person to drive a vehicle

(75) Inventors: Fouad Choucair, Montreal (CA); Martin Arsenault, Montreal (CA); Frederic Pichette, Lac Beauport (CA)

Correspondence Address: MERCHANT & GOULD PC, P.O. BOX 2903, MINNEAPOLIS, MN, 55402-0903, US

(73) Assignee: KOLOMBO TECHNOLOGIES LTEE, Ville Vanier (CA)

(21) Appl. No.: 11/369,357

(22) Filed: Mar. 6, 2006

(30) Foreign Application Priority Data
Jun. 15, 2005 (CA) 2,509,804

(51) Int. Cl. B60T 13/00

(52) U.S. Cl. 303/7

(57) ABSTRACT

The present invention provides a system and method for authorizing a user of a tractor-trailer to drive the tractor-trailer out of a plurality of tractors and trailers. The system comprises modules such as tractor modules and trailer modules. Each module comprises a user interface and a transceiver. A tractor module is located in each of the tractors and is uniquely associated with that tractor. The tractor module is also operatively associated with systems of that tractor. A trailer module is located in each of the trailers and is uniquely associated with that trailer. The trailer module is also operatively associated with systems of the trailer. In the system, a unique code is associated with each user and a central station sends this unique code to the modules, so that the modules enable the user to drive the tractor with the trailer.

### FIELD OF THE INVENTION

The present invention relates to the field of the freight transportation industry and more particularly to ground transportation by tractor-trailer.

### BACKGROUND OF THE INVENTION

As the truck industry expands, transportation companies own more and more equipment, such as tractor-trailers. This equipment carries heavier loads of merchandises. Supervising these equipment and merchandises has become more complex. As a result, it is harder to prevent financial losses due to thefts and trailer hitching errors. New national and international rules, in relation with terrorism and its follow ups, have also created several needs in terms of security management.

In terms of management, the available systems provide transporters with information such as the geographical position of their vehicles, covered mileage, and time-left until delivery of merchandises or how long a tractor has been parked. These systems are generally very expensive, because they use satellite waves or cellular telephones to send information. This information allows transporters to offer customers a better service while minimizing time loss. This information also allows transporters to keep customers aware of possible delivery delays. However, this information does not bring any concrete outcome to the transporters and does not prevent from hitching errors, thefts and terrorism either.

The available antitheft systems for tractors are similar to the ones available for cars, but they comprise more mechanical components such as gearshift locks. In theft prevention, a few systems exist as well for merchandises. They mainly consist of lock bars on back doors of vehicles or tracing systems hidden in merchandises. These latter systems are restricted to cellular-covered areas, and require specifically positioned antennae, which is hard to obtain considering the diversity of merchandises. Finally, while sending information, these systems are subjected to communication jamming.

In the prior art, WO 2004/029774 (GOUNDER) discloses a system for monitoring vehicles, but the system does not process authorizations. More generally, the prior art proposes several security systems for individual vehicles, but there is still a demand for security systems for handling a group of vehicles. U.S. Pat. No. 6,317,668, WO 2004/015637, WO 2004/014706 and WO 2004/014705, all owned by QUALCOMM INCORPORATED, are also pertinent to the present invention. For example, U.S. Pat. No. 6,108,591 proposes a system allowing to move one vehicle of a group and WO 2004/014705 teaches a system wherein a vehicle is started up and stopped if a user is unauthorized. However, there is still a need for security systems involving a complementary system also placed on the tractors and not only on the trailers.

Concerning trailers protection, the systems tend to be mechanical and consist of a steel piece attached to the stowage plug of the trailer to prevent the trailer from being displaced. However, these systems are not efficient, because thieves do not even try to remove that steel piece. Without hitching the trailer completely, they just move the trailer to an out-of-sight place and then, they take their time to commit their stealing.

### SUMMARY OF THE INVENTION

It is therefore an object of the present invention to provide a security system fulfilling some of the above-mentioned needs.

Thus, there is provided a system for authorizing a user of a tractor-trailer to drive said tractor-trailer out of a plurality of vehicles, said vehicles being tractors and trailers. The system comprising:
modules located on each of said vehicles, and systems of said vehicle being uniquely associated with said module located on the vehicle, each of said modules being provided with a transceiver, modules located on tractors being tractor modules and modules being located on trailers being trailer modules;
a unique code being associated with each user of said system; and
a central station, said central station being adapted to send to said modules the unique code of the user authorized to drive said tractor-trailer, so that upon receipt of said code, said modules enable said user to drive said tractor-trailer.

There is also provided a method for permitting a user to drive a tractor-trailer, comprising the steps of:
(a) providing the user with a unique code;
(b) providing a tractor module;
(c) providing a trailer module;
(d) with a central station, sending to the tractor module and the trailer module the unique code of the user;
(e) the user sending to the tractor module and the trailer module the unique code;
(f) at the trailer module and the tractor module, comparing the code received by the central station and by the user;
(g) enabling the user to drive the tractor associated with the trailer when the codes match.

The present invention will be more easily understood after reading the following description of a preferred embodiment made with reference to the figures.

### BRIEF DESCRIPTION OF THE FIGURES

FIG. 1 illustrates the different components of the entire system, according to a preferred embodiment of the invention.

FIGS. 2(A) and 2(B) illustrate the different components comprised in the tractor module, according to a preferred embodiment of the invention.

FIGS. 3(A) and 3(B) illustrate the electrical and pneumatic circuits of the tractor module, according to a preferred embodiment of the invention.

FIGS. 4(A) and 4(B) illustrate the components comprised in the trailer module, according to a preferred embodiment of the invention.

FIGS. 5(A) and 5(B) illustrate the electrical and pneumatic circuits of the trailer module, according to a preferred embodiment of the invention.

FIG. 6 illustrates the components comprised in the central station, according to a preferred embodiment of the invention.

FIG. 7 illustrates the components comprised in the keychain, according to a preferred embodiment of the invention.

FIG. 8 illustrates the components to use the keyboard, according to a preferred embodiment of the invention.

FIG. 9 illustrates the components comprised in the keyboard, according to a preferred embodiment of the invention.

FIG. 10 illustrates the components comprised in the cellular module, according to a preferred embodiment of the invention.

### DESCRIPTION OF A PREFERRED EMBODIMENT OF THE INVENTION

The present section describes a detailed embodiment of the system according to a preferred embodiment of the invention. In the following paragraphs, similar features have similar reference numbers.

Description of the Main Components of the System

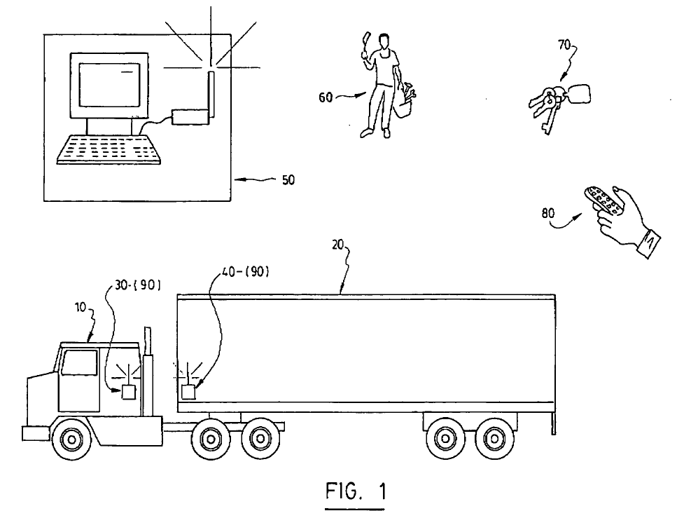

Referring to FIG. 1, there is provided a preferred embodiment of a system for authorizing a user (60) of a tractor-trailer to drive the tractor-trailer out of a plurality of tractors (10) and trailers (20). The system comprises a tractor module (30), a trailer module (40), a central station (50) and a unique code. Each of these modules (30 and 40) comprises its own controller (30 and 40) and at least one communication system. The unique code is associated with each user of the system. Preferably, the system further comprises a keychain (60), a wireless keyboard (80), and a cellular module (90). Preferably, the modules (30 and 40) are each further provided with a G.P.S. receiver. Several components also comprise a controller, and it will be understood that the controller can be substituted for a microcontroller (MCU).

The Tractor Module (30)

Components referred to in the present subsection are those of the tractor module (30) according to one preferred embodiment of the invention.

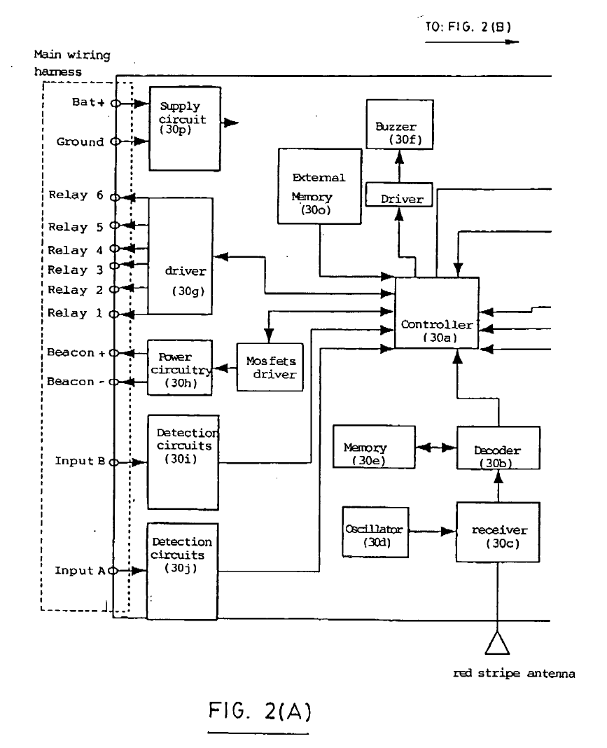

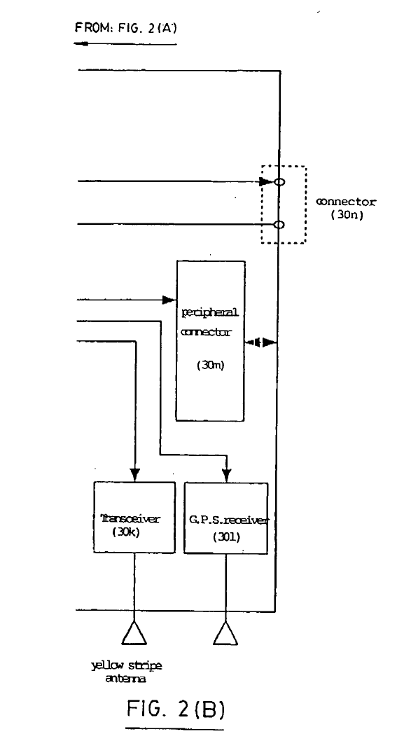

The tractor module (30) is best shown in FIGS. 2(A) and 2(B). The tractor module (30) is located in the tractor (10). The tractor module (30) comprises an interface for the user (60). The interface comprises more wires than are necessary for interconnection, so that wires can be randomly selected when operatively associating the tractor module (30) to the tractor (10). Consequently, from one tractor to the other the interconnections between the tractor and the corresponding module may not be the same, which is an additional antitheft tool in the system. The tractor module (30) is uniquely associated with the corresponding tractor (10).

The controller of the tractor module (30) is best shown in FIG. 2(A). The controller (30a) comprises a program performing the required operations according to the signals it receives. A peripheral connector (30m), for example a 36-contacts peripheral connector, optionally connects a cellular module (90) to the module (30) corresponding to the controller. Another connector (30n), for example a DIN connector, also connected to the controller (30a), allows interfacing peripheral equipment, such as the embedded scale weights, supplementary outputs, supplementary inputs or a system already in the tractor (10). An external memory (30o), for example an EEPROM, allows saving additional data and also updating the program of the controller (30a) through radio waves, without uninstalling the module (30). This memory (30o) also allows saving a complete history of the tractor (10) itineraries as well as all other necessary information requested by users, customers or external clearance systems such as customs systems.

The communication system of the present module (30) is best shown in FIGS. 2(A) and 2(B). A receiver (30c), for example a RF receiver, which receives waves of a frequency X, sends the code received from a keychain (70) to a decoder (30b) comprised in the module (30). The decoder (30b) verifies if the code is valid and if the code corresponds to the information encoded in a memory (30e) comprised in the module (30). If the code is valid, the decoder (30b) of the module (30) informs the controller (30a). A power circuit (30h) allows generating an electromagnetic field of a frequency W. The electromagnetic field of a frequency W activates a resonant circuit (70e) in the keychain (70). The tractor module (30) is provided with a transceiver (30k), for example a spread spectrum transceiver. The transceiver (30k) of a frequency Y communicates with the controller (30a) and allows bidirectional communication. The G.P.S. receiver (30l) is a receiver furnishing a position in real time to the controller (30a).

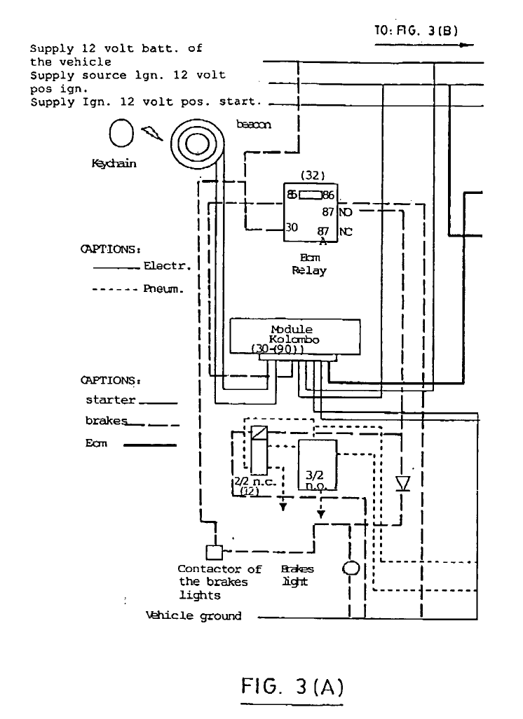

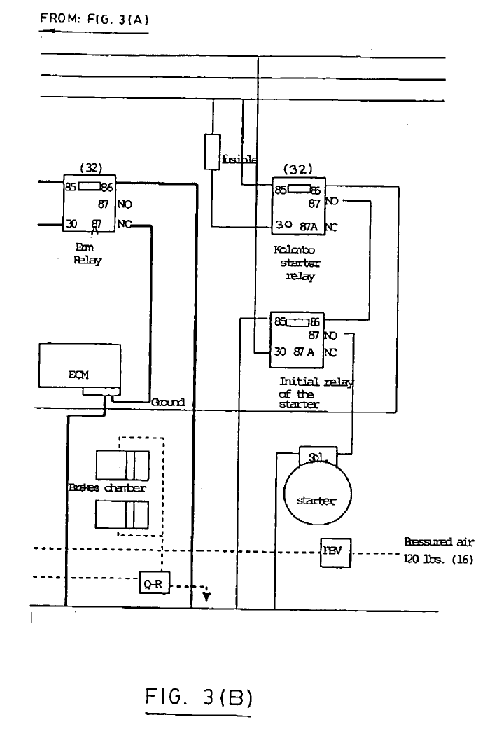

Referring to FIGS. 2(A), 2(B), 3(A) and 3(B), the tractor module (30) is operatively associated with systems of the tractor (10) and provided with a transceiver (30k). For example, the tractor module (30) is supplied by the 12-volt battery through a supplying circuit (30p), preferably a voltage and current limiting circuit. The 12-volt battery is located in the tractor (10). The tractor module (30) is associated with systems such as an ignition, a brake pedal and a brake system through detection circuits (30i and 30j), for example voltage and current limiting circuits. The detection circuits (30i and 30j) detect an ignition of the tractor (10) and a step on the brake pedal. A driver (30g), such as a MOSFETS relay driver, allows the activation of six relays (32), for example, for opening the tractor's (10) electrical circuits shown in FIGS. 3(A) and 3(B), in order to prevent the tractor (10) from moving off. The tractor module (30) is in a locked state by
(i) locking the brake system of the tractor (10) and
(ii) electronically disabling other components of the tractor-trailer until a valid code is received.

The locking of the brake system is activated by the driver (30g). The driver activates an electrovalve (12) which locks the brake system of the tractor (10), by emptying the air (16) as best shown in FIGS. 3(A) and 3(B). To inform the user of specific situations, the controller (30a) of the tractor module can activate for example a small speaker or a buzzer (30f).

The Trailer Module (40)

Components referred to in the present subsection are those of the trailer module (40) according to one preferred embodiment of the invention.

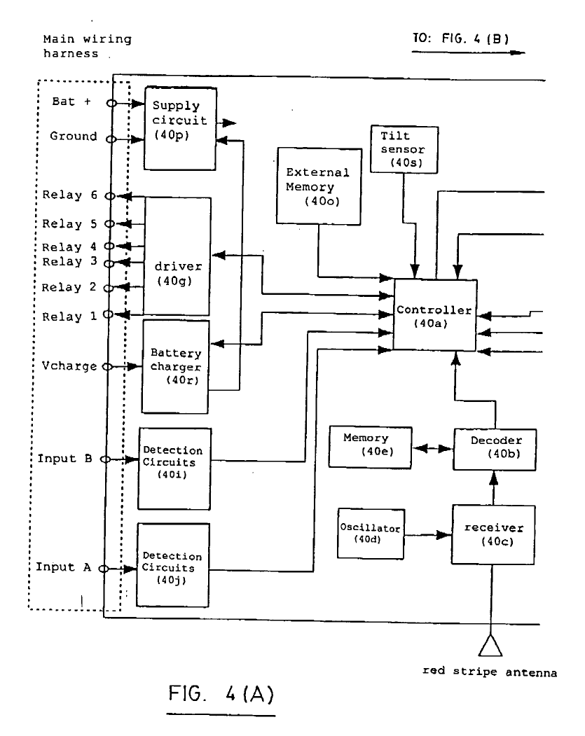

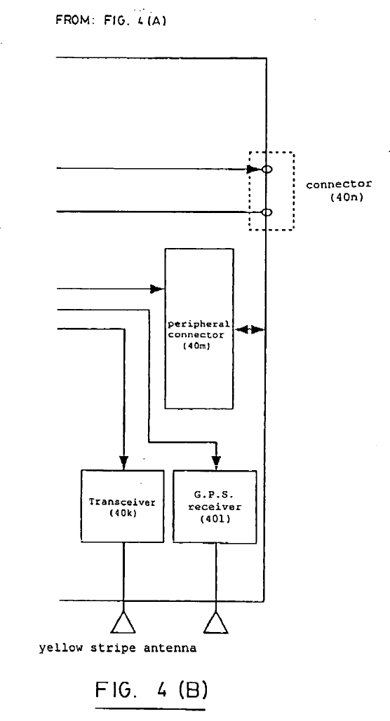

The trailer module (40) is best shown in FIGS. 4(A) and 4(B). The trailer module (40) is located in the trailer (20). The trailer module (40) comprises an interface for the user (60). The interface comprises more wires than are necessary for interconnection, so that wires can be randomly selected when operatively associating the trailer module (40) to the trailer (20). Consequently, from one trailer to the other, the interconnections between the trailer and the corresponding module may not be the same, which is an additional antitheft tool in the system. The trailer module (40) is uniquely associated with its corresponding trailer (20).

The controller of the trailer module (40) is best shown in FIG. 4(A). The controller (40a) comprises a program performing the required operations according to the signals it receives. A peripheral connector (40m), for example a 36-contacts peripheral connector, optionally connects a cellular module (90) to the module (40) corresponding to the controller. Another connector (40n), for example a DIN connector, also connected to the controller (40a), allows interfacing peripheral equipment such as the embedded scale weights, supplementary outputs, supplementary inputs or a system already therein the trailer (20). An external memory (40o), for example an EEPROM, allows saving additional data and also updating the program of the controller (40a) through radio waves, without uninstalling the module (40). This memory (40o) also allows saving a complete history of the trailer's (10) itineraries, as well as all other necessary information requested by users, customers or external clearance systems such as customs systems.

The communication system of the present module (40) is best shown in FIGS. 4(A) and 4(B). A receiver (40c), for example a RF receiver, which receives waves of a frequency X, sends the code received from a keychain (70) to a decoder (40b) comprised in the module (40). The decoder (40b) verifies if the code is valid and if the code corresponds to the information encoded in a memory (40e) comprised in the module (40). If the code is valid, the decoder (40b) of the module (40) informs the controller (40a). A power circuit (40h) allows generating an electromagnetic field of a frequency W. The electromagnetic field of a frequency W activates a resonant circuit (70e) in the keychain (70). The trailer module (40) is provided with a transceiver (40k) for example a spread spectrum transceiver. The transceiver (40k) of a frequency Y communicates with the controller (40a) and allows bidirectional communication. The G.P.S. receiver (40l) is a receiver furnishing to the controller (40a) a position in real time.

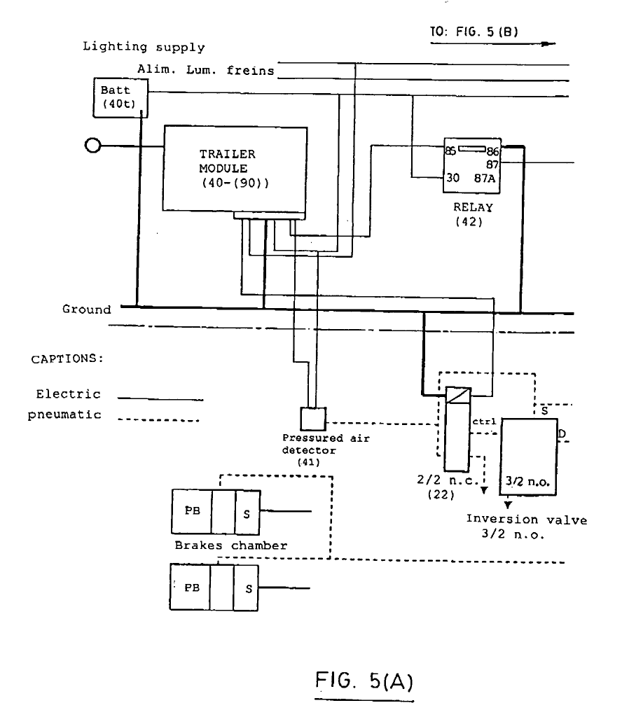

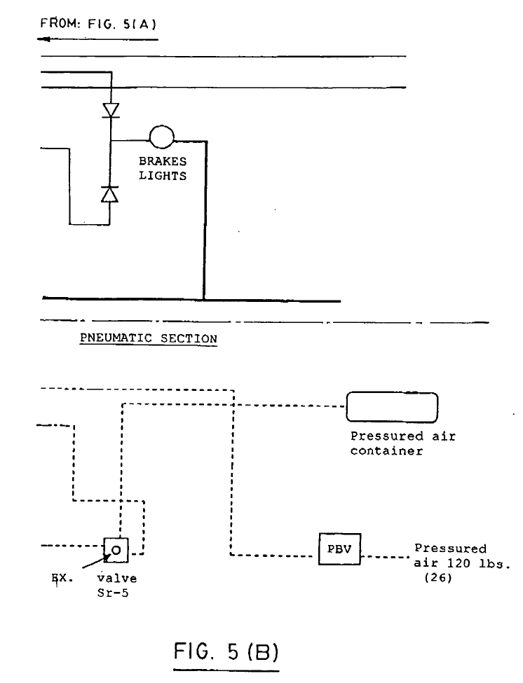

Referring to FIGS. 4(A), 4(B), 5(A) and 5(B), the trailer module (40) is operatively associated with systems of the trailer (20). For example, the trailer module (40) is supplied by a 12-volt independent battery (40t) through a supply circuit (40p), preferably a voltage and current limiting circuit. This battery reloads itself through a battery charger (40r) which interacts with a lighting circuit of the trailer (20). Preferably, the systems of the trailer (20) further comprise door sensors, temperature sensors, tilt sensors, or a combination thereof. For example, a movement detector such as a tilt sensor (40s) connected to the controller (40a) of the trailer module (40) allows detecting any unauthorized movement of the trailer (20). The trailer module (40) is also associated with systems such as a brake system through detection circuits (40i and 40j), for example voltage and current limiting circuits can be used as detection circuits (40i and 40j). The trailer module (40) is in a locked state by locking the brakes of the trailer (20) until a valid code is received. The detection circuits (40i and 40j) detect pressured air in the brake system of the trailer (20) by the means of a switch by a pressured air detector (41) shown in FIG. 5(A). The detection circuits (40i and 40j) allow detecting the opening of the back doors using a presence detector. A driver (40g), for example a MOSFETS relay driver, allows activating up to 6 relays (42); for example, the driver allows activating an electrovalve (22) which empties the air supply (26) at the trailer's (20) brakes and stops the trailer.

The Central Station (50)

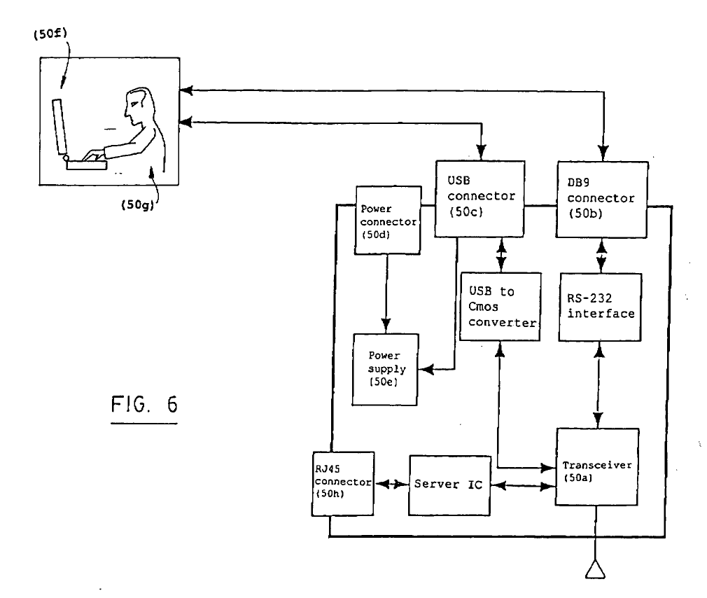

The central station (50) block diagram is best shown in FIG. 6. The central station (50) is adapted to send to the tractor module (30) and trailer module (40) the unique code of the user (60) authorized to drive the tractor (10) with the trailer (20), so that upon receipt of the code, the tractor module (30) and the trailer module (40) enable the user (60) to drive the tractor (10) with the trailer (20).

The central station (50) is preferably supplied either by an independent power supply connected through a power connector (50d) or by a USB connector (50c). The entire system is controlled by a power supply (50e).

The central station (50) is connected to a computer (50f), preferably through a DB9 connector (50b) or through a USB connector (50c) or through a connector RJ45 (50h) with a UDP or TCP protocol. The central station's transceiver (50a), which is a transceiver of a frequency Y, for example a spread spectrum transceiver of a frequency Y, and connected to the different connectors (50b, 50c, 50h), allows bidirectional communication between same type radios.

The information received by the central station (50) is sent to the computer (50f) comprising software with which an operator (50g) can interact. For example, the system according to the present invention is further operatively interconnected with an external clearance system. Preferably, the external clearance system is a customs system. Information relating to merchandises, user and destination are sent to the external clearance system, in order to reduce time spent at a clearance station.

The Keychain (70)

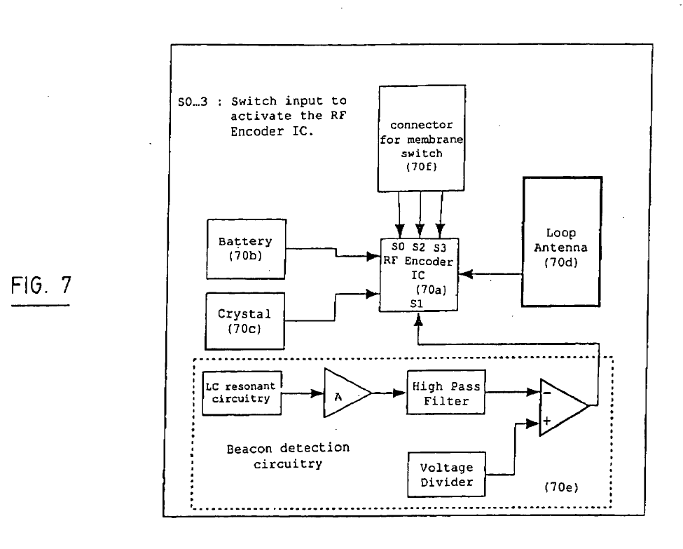

The keychain (70) block diagram is shown in FIG. 7. The keychain (70) carries the unique code. The keychain (70) is adapted to transmit the unique code. The keychain (70) is supplied by a battery (70b), for example, a 3 volt lithium battery.

One of the principal integrated circuit of the keychain is a code generator and an RF encoder (70a). A membrane keyboard is connected to a connector (70f), for example a ZIF connector, comprised in the keychain (70). When a button of the membrane keyboard is pressed, the generator generates an encrypted code and sends it through radio waves via the loop antenna (70d). The wave of a frequency X is generated from a crystal (70c). The encrypted code comprises a manufacturer is code programmed when manufacturing, a counter incrementing at each activation, a serial number, as well as information on the status of the keychain (70) (battery voltage, pressed button). The integrated circuit (70a) performs logical operations with all this information and creates an encrypted, rolling and unique code reusable for about the next 32000 uses of the keychain (70).

As mentioned above, the keychain (70) can also be activated through a resonant circuit (70e) sensitive to the electromagnetic field of a frequency W generated in each module (30 or 40). For example, if this field is created by the tractor module (30) through the power circuit (30h) and if the keychain (70) is within a radius of about 30 centimeters, the resonant circuit (70e) commands a button of the membrane keyboard (70f). Thus, the RF encoder (70a) sends the encrypted code through radio waves via the loop antenna (70d). For example, the resonant circuit comprises a beacon detection circuitry. A means for biometrical identification could also be used to validate the user (60).

The Keyboard (80)

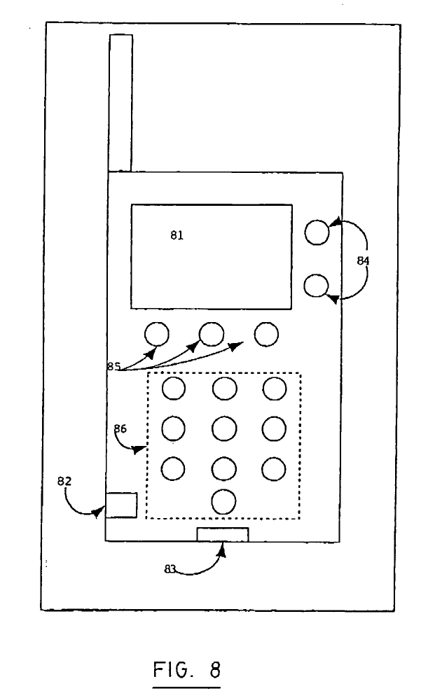

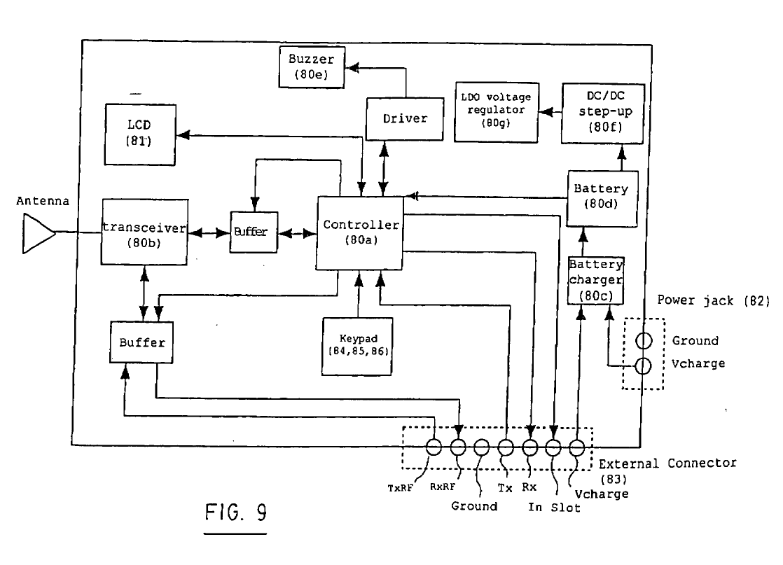

The keyboard (80) is shown in FIGS. 8 and 9. The unique code is sent using the keyboard (80). The keyboard (80) is preferably a wireless RF keyboard.

For example, the keyboard (80) is supplied by a lithium rechargeable 3.7-volt battery (80d) controlled by circuits such as a DC/DC step-up (80f) and an LDO voltage regulator (80g). The battery (80d) is rechargeable through a battery charger (80c), using a power Jack (82) or an external connector (83). Besides, the interface connector (83) allows programming information in a controller (80a) or adding means for biometrical identification. Information can also be displayed from the controller (80a), for example using a LCD (81).

The user (60) of the keyboard (80) uses the keys (84, 85, 86) to perform different tasks. The keypad comprises selection keys (85), menu keys (84) and numerical keys (86). The selection keys (85) allow navigating in a list and choosing items. The menu keys (84) allow navigating through the menus of the RF keyboard (80). The numerical keys (86) allow entering data.

The keyboard's transceiver (80b), preferably a spread spectrum transceiver of a frequency Y, is connected to the keyboard's controller (80a) and allows bidirectional communication between same type radios. To inform the user of specific situations, the keyboard's controller (80a) can activate a small buzzer (80e).

The Optional Cellular Module (90)

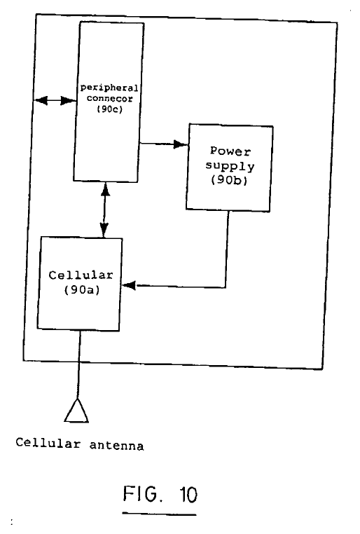

The optional cellular module (90) is shown in FIG. 10. The tractor module (30) is provided with the cellular module (90), for permitting cellular communication between the tractor module (30) and the central station (70). The cellular module (90) is optionally added to the tractor module (30) and the trailer module (40). The cellular module (90) is supplied via a peripheral connector (90c), for example a 36-contacts connector, connected to a vehicle connector which could either be the peripheral connector (30m) of the tractor module (30) or the peripheral connector (40m) of the trailer module (40). A power supply (90b) controls the supplying system of the cellular module (90). Preferably, the cellular (90a) is connected to the controller (30a) of the tractor module (30) via the peripheral connectors (90c-30m) of the tractor module (30) and cellular module (90). Preferably, the cellular (90a) is connected to the controller (40a) of the trailer module (40) via the peripheral connectors (90c-40m) of the trailer module (40) and cellular module (90).

Functioning of the System

The present invention also provides the user (60) with a method in real time for driving the tractor-trailer. The method comprises the steps of providing the user with the unique code, providing the tractor module (30), providing the trailer module (40), providing the central station (50), sending the unique code of the user to the tractor module (30) and trailer module (40). The method further comprises the steps of sending the unique code to the tractor module and trailer module. Thus the method compares the codes received by the central station (50) and by the user (60). The method also enables the user to drive the tractor (10) associated with the trailer (20) when the codes match.

Directions for the System's Installation

In order to install the system in a vehicle, for example, a programmer should obtain an encrypted file located on a provider's web site, for example under a section provided for programmers. There, the programmer can log in and fills the appropriate form with the customer's information.

Once the form completed, an encrypted file is generated and saved in the programmer's computer. The encrypted file comprises information about the customer's identity and vehicle. The file also comprises configuration data about the system and the number of keychains (70) the tractor module (30) or the trailer module can take (40). Each tractor module (30) and trailer module can take up to a predetermined maximum number of keychains (70), for example about seven. One keychain (70) according to the present embodiment of the invention can be associated with a plurality of tractor modules (30) and trailer modules (40).

Installation software, for example available on the provider's web site, enables the programmer to download the encrypted file in the tractor module (30) or trailer module (40). Thus, the programmer may program the authorized keychain (70).

Tractor Theft Prevention

Every time a valid keychain (70) is used to start up a tractor (10) comprising a tractor module (30), the tractor module (30) sends information about the starting up of the tractor (10) to the central station (50) via the transceiver (30k) at a frequency Y. The input circuit (30j) detects the starting up of the tractor. Similarly, when the same tractor (10) is shut down, the module (30) informs the central station (50) about the arrival of the tractor. This allows the central station (50) to be always aware of the status of the equipment. For example, the central station gets updates concerning which equipment is currently under the supervision of the central station.

At regular intervals, the tractor module (30) communicates with the central station (50). If the communication breaks between the central station and the tractor module, the tractor module (30) reports itself as stolen and sends an alarm, for example, by cutting the electric circuits of ignition, moving off and fuel supplying (15), also by emptying the air (16) in the brake system by activating the electrovalve (12) preventing all kinds of movements. This is allowed by the driver (30g). When communication breaks between the two modules, the central station (50) alerts the dispatcher that the tractor seems to be missing. This allows eliminating a possible hitching for stealing and also alerts of any attempt to jam the communication.

If the tractor (10) is started up without a keychain (70) to validate an authorization or a message concerning a displacement coming from a keyboard (80), the tractor module (30) stops the tractor (10) by cutting the electric circuits of ignition, moving off and fuel supplying (15), also by emptying the air (16) in the braking system by activating the electrovalve (12) preventing all kinds of movements. This is allowed by the driver (30g). Simultaneously, the tractor module (30) sends an alert to the central station (50) warning the dispatcher (50g) that an illegal starting up has been attempted. This message can also be received by the keyboard (80) which warns the user (60).

Using the entrance circuits (30i), the tractor module (30) can detect other signals such as for example doors opening. Any abnormal happening is either received by the central station (50) which sends them to the dispatcher (50g) or by the keyboard (80) which advises the user (60).

If the tractor (10) is started up with a valid keychain (70), the tractor (10) works correctly. The tractor module (30) is able to activate the keyboard (80) instead of the keychain (70).

However, if the tractor (10) is not within a reception radius of 2 km to receive the frequency Y wave of the central station (50), but comprises an optional cellular module (90), then the warnings are sent to the central station (50) using a cellular link. Every warning or alert is sent with information about the geographical position of the tractor (10) provided by the G.P.S. receiver (30l) of the tractor module (30).

Trailer Theft Prevention

Every time a trailer module (40) located in a trailer (20) detects, via the pressured air detector (41), the hitching of a tractor, the trailer module (40) automatically empties the air (26) in the pneumatic brakes which stops the trailer (20). This is allowed by the electrovalve (22). These features are best shown in FIGS. 5(A) and 5(B). As long as the trailer module (40) does not receive any confirmation, via the transceiver (40k) at a frequency Y, to validate the hitching, or via the keychain (70) to allow a movement, the trailer (20) remains motionless. If no confirmation is received after a predetermined delay, the trailer module (40) sends an alert to the central station (50) to warn the dispatcher (50g) or to the keyboard (80) to warn the user (60).

The message authorizing movement of the trailer (20) is received by the trailer module (40), via the transceiver (40k) of a frequency Y, and the message preferably comes from the keyboard (80), from the tractor module (10) or from the central station (50).

If the movement detector of the trailer module (40), for example the tilt sensor (40s), detects any movement of an unattached trailer (20) or any movement of a trailer hitched to an unauthorized tractor (10), then a warning is sent to the central station (50) or to the keyboard (80) via the transceiver (40k) of frequency Y.

If the trailer module (40) receives an authorization message within a predetermined delay, the trailer module (40) authorizes the trailer's (20) movement.

The trailer module (40) can detect, through the detection circuits (40i), other signals, for example, back doors opening. Any unauthorized happening is either received by the central station (50) which warns the dispatcher (50g) or by the keyboard (80) which warns the user (60).

However, if the trailer (20) is not within a reception radius of 2 km to receive the Y frequency wave of the central station (50), but comprises an optional cellular module (90), the optional cellular module (90) will end warnings or alerts to the central station (50) through a cellular link. Each warning or alert is sent with information about the geographical position provided by the G.P.S. receiver (40l) of the trailer module (40).

Reel Time Equipment Management

An important element of the present reel time equipment management system is dispatching software, installed in a computer of the central station (50). The software allows sending the following information to the dispatcher (50g): current status of the tractors and trailers (moving or parked), position of the tractors and trailers, status of the batteries, which tractor is hitched with which trailer, which user is driving which tractor, which communication link is available, detection of an anomaly in equipment's usage or linkage.

The software allows scheduling the equipment departures and ensuring correct associations and correspondences between the user (60), tractor (10) and trailer (20). To perform these actions, using the software the dispatcher (50g) selects the user(s) (60), tractor(s) (10) and trailer(s) (20) to associate.

All RF emissions sent via the transceivers (30k, 40k, 50a and 80b) are encrypted.

Tractor Module (30) Supervision System

If a valid keychain (70) or keyboard (80) starts up the tractor (10), the tractor module (30), via the transceiver (30k) comprised within the tractor module (30), warns the central station (50). The central station (50) identifies the keychain (70) or the keyboard (80) used to perform the starting up. As the data base of the dispatching software links each keychain (70) or keyboard (80) to a user (60), the dispatcher (50g) knows who is driving the tractor (10). Following the starting up of the tractor (10), the central station (50) informs the tractor module (30) of the corresponding equipment to carry.

When the tractor (10) works, if there is a free communication way, it is possible to inquire, via the transceiver (30k), information about the tractor module (30), for example, inquiring about its position or diagnosing problems. The user (60) can open a predetermined gate by pressing on a preset button of the keychain (70): the keychain (70) sends to the central station (50), through a receiver (30c), a code, which starts a transmission, via the transceiver (30k) of the tractor module (30), to request the opening of the gate. The dispatching software checks if the message is valid. If the message is valid, the dispatching software advises the dispatcher (50g) and opens the gate immediately, knowing that the corresponding equipment is valid.

At regular intervals, the tractor module (30) checks if the tractor (10) is still in an area covered by the central station (50). If the tractor module (30) is out of reach and equipped with an optional cellular mode (90), the tractor module (30) will keep checking the status of the tractor until the tractor (10) gets back in an area covered by the central station (50).

Trailer Module (40) Supervision System

When the trailer (40) detects air pressure, via the pressured air detector (41) switch, the trailer (40) warns, via the transceiver (40k), the central station (50). Thus the central station (50) advises the dispatcher (50g) and informs the trailer module (40) about the equipment to carry. Then the trailer module (40) checks with the tractor module (30) of the tractor (10) that tows the trailer (20) if the equipment expected according the tractor module's (30) data corresponds to the one expected according to the trailer module's (40) data. If the data match, the tractor module (30) sends an authorization code to the trailer module (40). The trailer module (40) then authorizes the trailer (20) to move. The trailer module (40) informs the central station (50) that the trailer (20) is authorized to be hitched to and towed by the tractor (10).

When the trailer (20) works, if there is a free communication way, it is possible to inquire about information about the trailer, for example, inquiring about the trailer position or diagnosing the system. At regular intervals, the trailer module (40) checks if the trailer (20) is still in an area covered by the central station (50). If the trailer module (40) is out of reach and equipped with an optional cellular module (90), the trailer module (40) will keep checking the status of the trailer until the trailer (10) gets back in an area covered of the central station (50).

Keyboard (80) Supervision System

In order to use the keyboard (80), a user should enter a personal identification code. The keyboard (80) is programmable via a connector interface (83).

It is possible to program the usage of the keyboard (80) for a certain period of time. When the period is over, the keyboard (80) resets itself and becomes unusable. Consequently, in case of theft, its usage is controlled.

It is also possible to program a list of tractors (10) and trailers (20) which access is granted to selected users (60).

The keyboard (80) can also receive, via the transceiver (80b), warnings and alerts from the trailer module (40) and the tractor module (30).

Of course, the above-described embodiments are only illustrative examples of what could be accomplished with the present invention. Furthermore, it should be understood that numerous modifications could be made to the embodiments as described herein, without departing from the scope of the invention as apparent to a person skilled in the art.

1. A system for authorizing a user of a tractor-trailer to drive said tractor-trailer out of a plurality of vehicles, said vehicles being tractors and trailers, said system comprising:
modules located on each of said vehicles, and systems of said vehicle being uniquely associated with said module located on the vehicle, each of said modules being provided with a transceiver, modules located on tractors being tractor modules and modules being located on trailers being trailer modules;
a unique code being associated with each user of said system; and
a central station, said central station being adapted to send to said modules the unique code of the user authorized to drive said tractor-trailer, so that upon receipt of said code, said modules enable said user to drive said tractor-trailer.

2. A system according to claim 1, wherein said unique code is carried by said user in a keychain, said keychain being adapted to transmit said unique code.

3. A system according to claim 2, wherein each module comprises an electromagnetic field generator, said electromagnetic field generator producing an electromagnetic field, said electromagnetic field activating a resonant circuit comprised in the keychain.

4. A system according to claim 1, wherein said unique code is sent using a wireless keyboard.

5. A system according to claim 1, wherein each module comprises means for decoding the unique code.

6. A system according to claim 1, wherein each module comprises a controller, said controller comprising a program performing operations according to received signals.

7. A system according to claim 1, wherein each module is provided with an interface operatively associating the module with the vehicle comprising the module; wherein said physical interface of the module comprises more wires than are necessary for interconnection; and wherein said wires can be randomly selected to interconnect said module to said vehicle when operatively associating said module to said vehicle.

8. A system according to claim 1, wherein each module comprises a system for preventing the vehicle from moving.

9. A system according to claim 1, wherein each module is supplied by a power supply of the vehicle.

10. A system according to claim 1, wherein each module is further provided with a cellular module for cellular communication between said module and said central station.

11. A system according to claim 1, wherein each module is associated with systems of said vehicle, said systems of said vehicle comprising an ignition or a brake pedal or a brake system or a combination thereof.

12. A system according to claim 11, wherein each module is associated with a detecting system for detecting an ignition of the tractor and for detecting a step on a brake pedal of said vehicle.

13. A system according to claim 11, wherein said tractor module is in a locked state by looking the brakes of said tractor and electronically disabling components comprised in the tractor until a valid code is received.

14. A system according to claim 1, wherein a connector allows remotely interfacing peripheral equipment comprised in the tractor-trailer.

15. A system according to claim 1, wherein said tractor module and said trailer module are each further provided with a G.P.S. receiver, said G.P.S. receiver module which indicates, in real time, the vehicle's position to the controller.

16. A system according to claim 1, wherein said systems of said vehicle further comprise door sensors or temperature sensors or tilt sensors or buzzers or a combination thereof.

17. A system according to claim 1, wherein said module is in a locked state by locking the brakes of said vehicle until a valid code is received.

18. A system according to claim 1, wherein said system is further operatively interconnected with an external clearance system, whereby information relating to merchandises, user and destination are sent to said external clearance system.

19. A system according to claim 19, wherein said external clearance system is a customs system.

20. A system according to claim 1, wherein authorizing messages for movements of each vehicle are received by the vehicle's module, via the transceiver of the module, said messages being received from the keyboard, from another vehicle's module or from the central station.

21. A method for permitting a user to drive a tractor-trailer, comprising the steps of:
(a) providing said user with a unique code;
(b) providing a tractor module;
(c) providing a trailer module;
(d) with a central station, sending to said tractor module and said trailer module said unique code of said user;
(e) said user sending to said tractor module and said trailer module said unique code;
(f) at said trailer module and said tractor module, comparing said code received by said central station and by said user;
(g) enabling said user to drive said tractor associated with said trailer when said codes match.

22. A method according to claim 21, wherein said user sends said code with a keychain bearing said code.

23. A method according to claim 21, wherein said user sends said code with a wireless keyboard.

24. A method according to claim 22, wherein said keychain is associated with a plurality of tractor modules and trailer modules.
